(19) United States
(12) Patent Application Publication
(10) Pub. No.: US 2007/0267185 A1
(43) Pub. Date: Nov. 22, 2007

(54) Header for high pressure heat exchanger

(76) Inventors: Hong Yeol Lee, Asan-si (KR); Jeong Sang Park, Asan-si (KR)

Correspondence Address: DICKSTEIN SHAPIRO LLP, 1825 EYE STREET NW, Washington, DC, 20006-5403, US

(21) Appl. No.: 11/730,876

(22) Filed: Apr. 4, 2007

(30) Foreign Application Priority Data
May 18, 2006 (KR) 10-2006-0044731
May 19, 2006 (KR) 10-2006-0044944

(51) Int. Cl. F16L 41/00; F28F 9/02

(52) U.S. Cl. 165/173

(57) ABSTRACT

A header for high pressure heat exchanger, according to the present invention, includes a header body with a plurality of supporting members longitudinally formed and a cover plate combined and closely contacting the supporting members such that a space is formed between the header body and the cover plate, in which inserting grooves to insert the ends of tubes thereinto are formed at the supporting members, and tube inserting holes to insert the tubes are formed at the cover plate. Accordingly, it is easy to assemble and braze the header and tubes, and the cross section of the header is reduced and pressure proof is improved as well.

### BACKGROUND OF THE INVENTION

1. Field of the Invention

The present invention relates to a header for high pressure heat exchanger and, particularly, to a header for high pressure heat exchanger having improved characteristics in assembling and pressure-proofing.

2. Description of the Related Art

In general, an HFC refrigerant is mainly used for working fluid of air conditioners including a heat exchanger, but it has been considered as one of the main causes for global warming, so that the restriction imposed on the use is gradually increasing and researches for a next generation carbon dioxide to replace the HFC refrigerant are actively in progress.

Because high pressure heat exchangers using a carbon dioxide refrigerant operate under ten times higher pressure as compared with existing heat exchangers using an HFC refrigerant and require high pressure proof, headers having a variety of configurations with high pressure proof has been proposed.

FIG. 1 shows an example of a header 10 for high pressure heat exchangers in the related art. Referring to FIG. 1, two header parts 12, 14 are combined by welding such that channels R1, R2 are formed between them, tube inserting holes 12a, to which tubes are inserted, are formed at a header part 12, and the channels R1, R2 are separated by thick partitions 12b, 14b, thereby increasing rigidity of the header 10.

As described above, such headers for high pressure heat exchangers have low pressure proof and poor processability compared with the cross-sectional area of the header.

### SUMMARY OF THE INVENTION

Accordingly, designed to overcome the above problems, an object of the present invention is to provide a header for high pressure heat exchanger that allows easy assembling and brazing of headers and tubes, and increases pressure proof when reducing the cross-sectional area of the header.

In order to achieve the above objects, a header for high pressure heat exchanger according to an aspect of the invention includes a header body with a plurality of supporting members longitudinally formed and a cover plate that is combined and closely contacting with the supporting members such that a space is formed between the header body and the cover plate, in which inserting grooves to insert the ends of tubes thereinto are formed at the supporting members and tube inserting holes to insert the tubes are formed at the cover plate.

A header for high pressure heat exchanger according to another aspect of the invention includes a header body with a plurality of supporting members longitudinally formed, a cover plate that is combined and closely contacting with the supporting members such that a space is formed between the header body and the cover plate, and a reinforcement plate that is closely brazed to the cover plate and combined with the header body, covering both side ends of the width direction of the header body, wherein inserting grooves to insert the ends of tubes thereinto are formed in the supporting members and tube inserting holes to insert the tubes are formed in the reinforcement plate.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view of an example of conventional headers for high pressure heat exchanger;

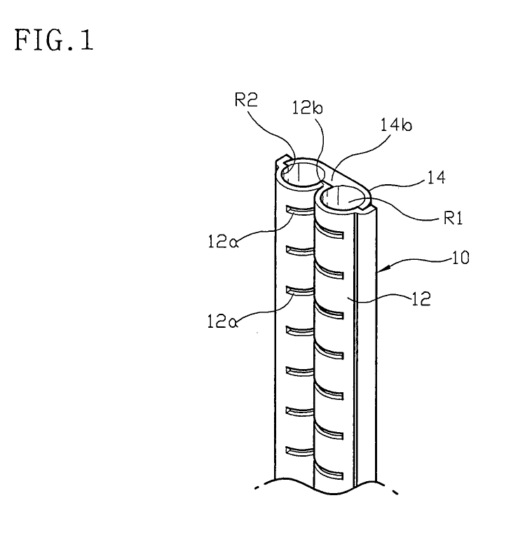

FIG. 2 is a view showing the configuration of a high pressure heat exchanger where the invention is applied;

FIG. 3 is a perspective exploded view showing a part of a header for high pressure heat exchanger according to a first embodiment;

FIG. 4 is a perspective assembly view of the header for high pressure heat exchanger according to the first embodiment;

FIG. 5 is a perspective view of inserting grooves formed at a supporting member of the header body of FIG. 3;

FIG. 6 is a perspective assembly view showing a part of a header for high pressure heat exchanger according to a second embodiment;

FIG. 7 is a perspective assembly view showing a part of a header for high pressure heat exchanger according to a third embodiment of the invention;

FIG. 8 is a perspective exploded view showing a part of a header for high pressure heat exchanger according to a fourth embodiment;

FIG. 9 is a detail view of the portion represented by ‘A’ of FIG. 8;

FIG. 10 is a cross-sectional assembly view of the header for high pressure heat exchanger according to the fourth embodiment of the invention; and

FIG. 11 is a cross-sectional view taken along the line B-B of FIG. 10.

### DESCRIPTION OF THE PREFERRED EMBODIMENTS

Hereinafter, a detailed description will be given of the present invention.

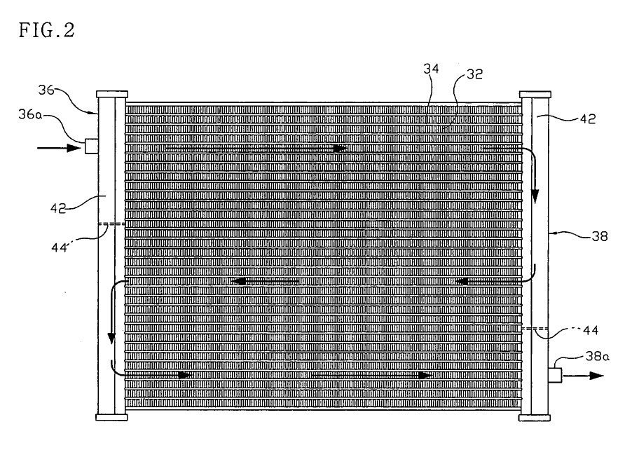

FIG. 2 shows the configuration of a high pressure heat exchanger where the invention is applied. Referring to FIG. 2, a number of tubes 34 having a number of radiating fins 32 that take heat from high-pressure and high-temperature refrigerant compressed in a compressor are arranged parallel with one another. Headers 36, 38 are vertically disposed at both sides of the tubes 34 and communicate with each other, and a refrigerant inlet port 36a and a refrigerant outlet port 38a are formed in the headers 36, 38.

A baffle 44 is provided in the headers 36, 38. As shown by arrows in FIG. 2, the baffle 44 allows the refrigerant to flow in a zigzag pattern between the headers 36, 38 through the tubes 34. The baffle 44 also reinforces the headers 36, 38. Both ends of the headers 36, 38 are closed by caps, respectively.

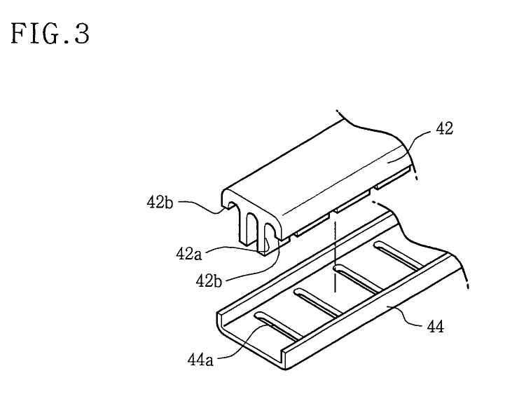

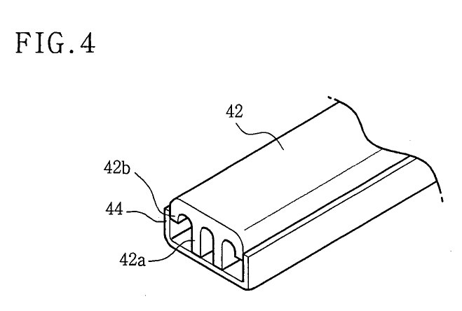

FIGS. 3 and 4 are a perspective exploded view and a perspective assembly view of a part of a header for high pressure heat exchanger according to a first embodiment of the invention, respectively. Referring to FIGS. 3 and 4, the headers 36, 38 are composed of a header body 42 with a plurality of protruding supporting members 42a, and a cover plate 44 that is combined with the header body 42 and forms a space between the header body 42 and the cover plate 44.

Protruding from the header body 42, the supporting members 42a are formed along the longitudinal direction of the header body 42 and closely contact the inner side of the cover plate 44. The supporting members 42a further protrude beyond both side ends 42b of the width direction of the header body 42, and have a small cross section.

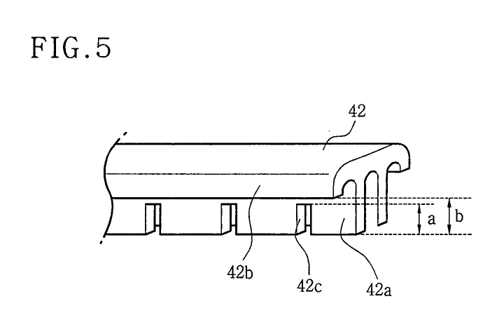

As shown in FIG. 5, inserting grooves 42c to insert the ends of the tubes 34 are formed in the supporting members 42a.

The depth ‘a’ of the inserting groove 42c is smaller than the distance ‘b’ from the lower end of the supporting member 42a to the side end 42b. According to such configuration, it is easy to form the inserting groove 42c. In addition, a refrigerant can easily flow through the space between the side ends of the header body 42 and the inside of the cover plate 44, so that flowability of the refrigerant is improved.

The cover plate 44 has a [symbol] -shaped cross section with flanges on both sides thereof. The flanges closely contact with the side surfaces of the side ends 42b of the header body 42, and cover a part of the header body 42. Clad material is coated on the inner side of the cover plate 44 to be brazed with the header body 42. Tube inserting holes 44a to insert the ends of the tubes 34 are formed in the cover plate 44. The cover plate 44 may be formed by press working.

The above clad material coated on the inner side of the cover plate 44 is a common clad material of aluminum.

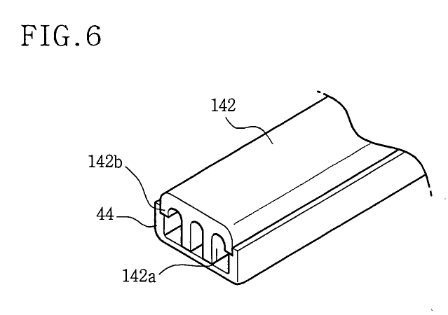

FIG. 6 is a perspective assembly view showing a part of a header for high pressure heat exchanger according to a second embodiment of the invention. The header according to the second embodiment has a configuration where both side ends 142b of a header body 142 are placed on steps formed on flanges of a cover plate 144 and brazed. The other part including supporting members 142a are the same as in the configuration of the first embodiment.

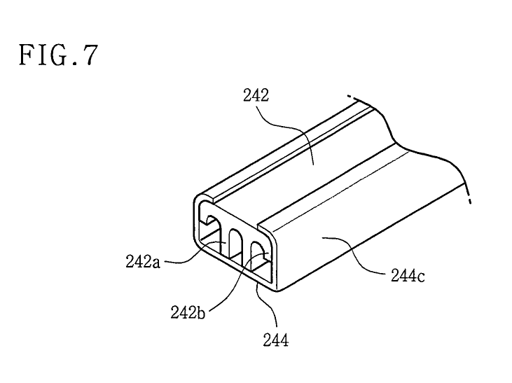

FIG. 7 is a perspective assembly view showing a part of a header for high-pressure heat exchanger according to a third embodiment of the invention. The header according to the third embodiment has a configuration where flanges 244c of a cover plate 244 thoroughly cover both side ends 242b of a header body 242 by being bended over the upper surface (base surface) of the header body 242, and then the cover plate 244 is in close contact with the header body 242 by being brazed. The other parts including supporting members 242a are the same as in the configuration of the first embodiment.

Such headers for high pressure heat exchanger improves pressure proof because the supporting members 42a protruding from the center portion of the header body 42 support the cover plate 44. Further, the supporting member 42a is composed of a number of supporting members 42a having a small cross-sectional area, so that the area of channels inside the header increases and heat exchange rate rises as well.

In addition, the inserting groove 42c formed in the supporting member 42a steadily holds the tube 34 and raises durability. As described above, since the depth ‘a’ of the inserting groove 42c is smaller than the distance ‘b’ from the lower end of the supporting member 42a to the side end 42b, it is easy to form the inserting groove 42c. Further, a refrigerant can easily flow through the space between the side ends of the header body 42 and the inside of the cover plate 44, so that flowability of the refrigerant is improved.

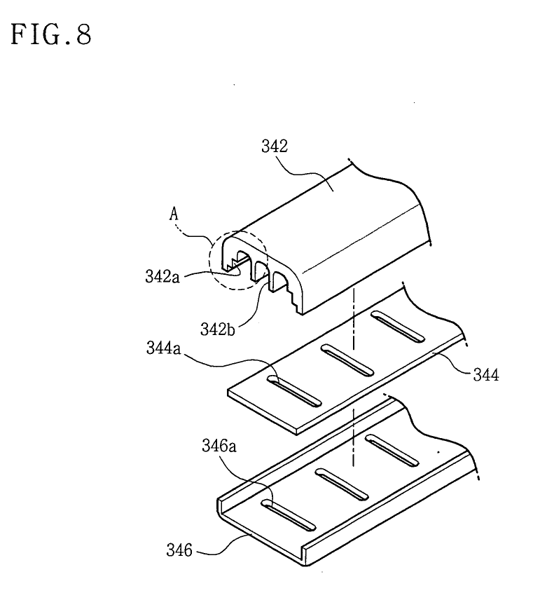

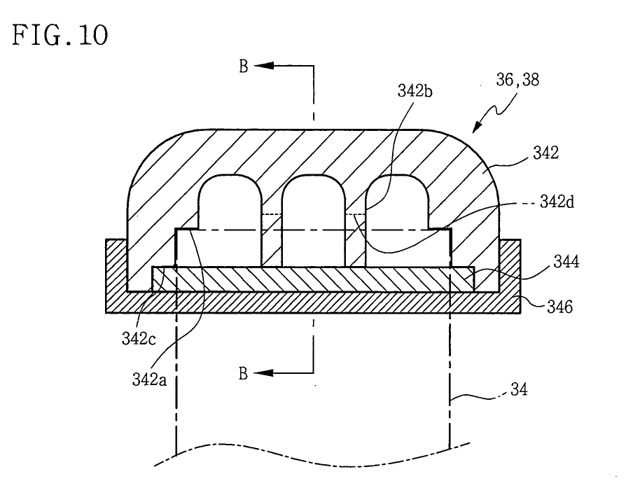

FIGS. 8 to 11 show a fourth embodiment of the invention, in which the headers 36 and 38 are composed of a header body 342 having tube stoppers 342a on which the ends of the tubes 34 are placed, a cover plate 344 that is combined with the header body 342 by being brazed such that a space is formed between the cover plate 344 and the header body 342, and that is coated with a clad material on both surfaces of the cover plate 344 and has tube inserting holes 344a to insert the tubes 34, and a reinforcement plate 346 that is in close contact and is brazed with the cover plate 344 such that the reinforcement plate 346 covers a part of the header body 342, and that has tube inserting holes 346a to insert the tubes 34.Formed inside the header body 342 and is in close contact with the cover plate 344 to support the cover plate 344, a plurality of supporting members 342b protrude from the header body 342 along the longitudinal direction of the header body 342. At the lower ends of the header body 342, plate stoppers 342c are formed to place both ends of the width direction of the cover plate 344.

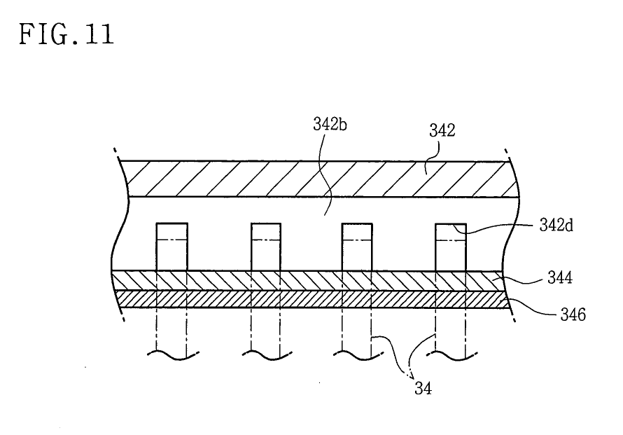

As shown in FIG. 11, inserting grooves 342d are formed in the supporting members 342b for closely fitting the tubes 34. The depth of the inserting groove 342d is bigger than the depth of the tube stopper 342a, so that a refrigerant can flow through the supporting members 342b.

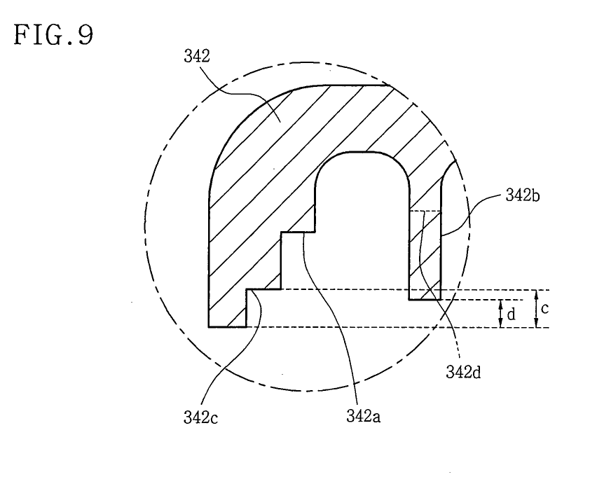

As shown in FIG. 9, the depth ‘c’ of the plate stopper 342c from the lower end of the header body 342 is biggger than the distance ‘d’ from the lower end of the header body 342 to the lower end of the supporting member 342b, so that the supporting members 342b are pressed and adhered to the coated portion with the clad material on the cover plate 344 to increase supporting force. Difference between the depth ‘c’ and distance ‘d’ does not exceed the thickness of the coated clad material.

Having a [symbol] -shaped cross section, the reinforcement plate 346 covers the header body 342 and the cover plate 344. A clad material is coated on the reinforcement plate 346 closely contacting the cover plate 344 to improve brazability.

According to a header for a high-pressure heat exchanger having the above configuration, the ends of the tubes 34 are placed on the tube stoppers 342a of the header body 342 and steadily held, so that the brazed portion is not damaged, pressure proof is increased, and it is easy to assemble the tubes 34 and braze them.

Further, pressure proof and durability of the headers 36, 38 are increased by the reinforcement plate 346 and the supporting members 342b supporting the cover plate 344.

As described above, according to headers for the high-pressure heat exchanger according to the embodiments of the invention, advantages are found in that assembling and brazing of the headers and tubes are easy and the cross-sectional area of the headers is reduced while pressure proof is increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A header for high pressure heat exchanger, comprising:
a header body with a plurality of supporting members longitudinally formed; and
a cover plate combined and closely contacting with the supporting members such that a space is formed between the header body and the cover plate,
wherein inserting grooves to insert the ends of tubes thereinto are formed in the supporting members and tube inserting holes to insert the tubes thereinto are formed in the cover plate.

2. The header as set forth in claim 1, wherein the depth of the inserting groove is smaller than the distance from the lower end of the supporting member to the side end of the width direction of the header body.

3. The header as set forth in claim 1, wherein the cover plate has a [symbol] -shaped cross section with flanges on both sides of the width direction of the cover plate, and the cover plate is combined with the header body by welding such that the flanges on both sides closely contact with the side surfaces of the side ends of the width direction of the header body and cover a part of the header body, and wherein a clad material is coated on the inner side of the cover plate to be brazed with the header body.

4. The header as set forth in claim 1, wherein the cover plate has a [symbol] -shaped cross section with flanges on both sides of the width direction of the cover plate, and steps on which the side ends of the width direction of the header body are placed are formed on the both sides of the cover plate, and wherein a clad material is coated on the inner side of the cover plate to be brazed with the header body.

5. The header as set forth in claim 1, wherein the cover plate has a [symbol] -shaped cross section with flanges on both sides of the width direction of the cover plate, and the cover plate is combined with the header body by welding such that the flanges on both sides thoroughly cover both side ends of the width direction of the header body, and wherein a clad material is coated on the inner side of the cover plate to be brazed with the header body.

6. A header for high pressure heat exchanger, comprising:
a header body with a plurality of supporting members longitudinally formed;
a cover plate combined with the header body such that a space is formed between the cover plate and the header body; and
a reinforcement plate closely brazed with the cover plate and combined with the header body, covering both side ends of the width direction of the header body;
wherein inserting grooves to insert the ends of tubes thereinto are formed in the supporting members and tube inserting holes to insert the tubes are formed in the reinforcement plate.

7. The header as set forth in claim 6, wherein a clad material is coated on the cover plate to be brazed with the header body.

8. The header as set forth in claim 6, wherein tube stoppers on which the ends of the tubes are placed are formed in the header body, and the depth of the inserting groove is larger than the depth of the tube stopper so that a refrigerant can flow through the supporting members.

9. The header as set forth in claim 6, wherein plate stoppers on which both ends of the width direction of the cover plate are placed are formed on the lower side ends of the width direction of the header body.

10. The header as set forth in claim 9, wherein the depth of the plate stopper from the lower end of the header body is larger than the distance from the lower end of the header body to the lower end of the supporting member so that the supporting members pressed and adhered to the coated portion with the clad material on the cover plate increase supporting force.

11. The header as set forth in claim 6, wherein the reinforce plate has a [symbol] -shaped cross section and a clad material is coated on the inner side of the reinforcement plate that closely contact with the cover plate for brazing.
